(19) United States
(12) Patent Application Publication
(10) Pub. No.: US 2024/0329477 A1
(43) Pub. Date: Oct. 3, 2024

(54) ELECTRONIC DEVICE

(71) Applicant: InnoLux Corporation, Miao-Li County (TW)

(72) Inventors: Ming-Jou TAI, Miao-Li County (TW); Chia-Hao TSAI, Miao-Li County (TW)

(73) Assignee: InnoLux Corporation, Miao-Li County (TW)

(21) Appl. No.: 18/583,833

(22) Filed: Feb. 21, 2024

(30) Foreign Application Priority Data
Mar. 30, 2023 (CN) 202310326778.0

(51) Int. Cl. G02F 1/1368

(52) U.S. Cl. CPC G02F 1/1368

(57) ABSTRACT

An electronic device includes a substrate, a thin-film transistor, a first organic layer, a transparent conductive layer, a second organic layer, a first spacer and a second spacer. The thin-film transistor is disposed on the substrate. The first organic layer is disposed on the thin-film transistor and has a via. The transparent conductive layer is disposed on the first organic layer and electrically connected to the thin-film transistor through the via. The second organic layer is at least partially disposed in the via. The first spacer is disposed on the second organic layer. The second spacer is disposed on the first spacer, in which the second organic layer, the first spacer and the second spacer at least partially overlap each other.

### BACKGROUND OF THE DISCLOSURE

### 1. Field of the Disclosure

The present disclosure relates to an electronic device, and more particularly, to an electronic device with high resolution.

### 2. Description of the Prior Art

With the advancement of technology, electronic devices equipped with displays have become indispensable in modern life. However, the electronic devices have not yet met expectations in all aspects. With the enhancement of resolution and the reduction of pixel area, how to improve the resolution and the process yield of the electronic devices is still one of the goals of the industry. For example, the patterns in the pixel are very dense. As a result, the height of the film layer in the pixel undulates frequently, which tends to affect the stability for supporting the cell gap. As another example, when applied to liquid crystal display devices, the undulating height of the film layer may affect the arrangement of the liquid crystal, which affects the display quality.

### SUMMARY OF THE DISCLOSURE

According to an embodiment of the present disclosure, an electronic device includes a substrate, a thin-film transistor, a first organic layer, a transparent conductive layer, a second organic layer, a first spacer and a second spacer. The thin-film transistor is disposed on the substrate. The first organic layer is disposed on the thin-film transistor and has a via. The transparent conductive layer is disposed on the first organic layer and electrically connected to the thin-film transistor through the via. The second organic layer is at least partially disposed in the via. The first spacer is disposed on the second organic layer. The second spacer is disposed on the first spacer, in which the second organic layer, the first spacer and the second spacer at least partially overlap each other.

According to another embodiment of the present disclosure, an electronic device includes a substrate, a thin-film transistor, a first organic layer, a transparent conductive layer, a second organic layer and a first spacer. The thin-film transistor is disposed on the substrate. The first organic layer is disposed on the thin-film transistor and has a via. The transparent conductive layer is disposed on the first organic layer and electrically connected to the thin-film transistor through the via. The second organic layer is at least partially disposed in the via. The first spacer is disposed on the second organic layer and overlaps the second organic layer, in which the transparent conductive layer is disposed between the first spacer and the second organic layer, in a cross-sectional view of the electronic device, a first width of the first spacer close to the second organic layer is less than a second width of the first spacer away from the second organic layer.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram showing a top view of an electronic device according to an embodiment of the present disclosure.

FIG. 2 is a schematic diagram showing a partial cross-sectional view taken along line A-A′ of the electronic device shown in FIG. 1.

FIG. 3 is a schematic diagram showing a partial cross-sectional view of an electronic device according to another embodiment of the present disclosure.

FIG. 4 is a schematic diagram showing a partial cross-sectional view of an electronic device according to further another embodiment of the present disclosure.

FIG. 5 is a schematic diagram showing a partial cross-sectional view of an electronic device according to yet another embodiment of the present disclosure.

FIG. 6 is a schematic diagram showing a partial cross-sectional view of an electronic device according to yet another embodiment of the present disclosure.

FIG. 7 is a schematic diagram showing a partial cross-sectional view of an electronic device according to yet another embodiment of the present disclosure.

FIG. 8 is a schematic diagram showing a partial cross-sectional view of an electronic device according to yet another embodiment of the present disclosure.

FIG. 9 is a schematic diagram showing a partial cross-sectional view of an electronic device according to yet another embodiment of the present disclosure.

FIG. 10 is a schematic diagram showing a partial cross-sectional view of an electronic device according to yet another embodiment of the present disclosure.

FIG. 11 is a schematic diagram showing a partial cross-sectional view of an electronic device according to yet another embodiment of the present disclosure.

### DETAILED DESCRIPTION

The present disclosure may be understood by reference to the following detailed description, taken in conjunction with the drawings as described below. Wherever possible, the same or similar parts in the drawings and descriptions are represented by the same reference numeral.

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include/comprise” and “have” are used in an open-ended fashion, and thus should be interpreted to mean “include, but not limited to . . . ”.

In the present disclosure, the directional terms, such as “on/up/above”, “down/below”, “front”, “rear/back”, “left”, “right”, etc., are only directions referring to the drawings. Therefore, the directional terms are used for explaining and not used for limiting the present disclosure. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

In the present disclosure, when a structure (or layer, or component, or substrate) is described as located on/above another structure (or layer, or component, or substrate), it may refer that the two structures are adjacent and directly connected with each other, or the two structures are adjacent and indirectly connected with each other. The two structures being indirectly connected with each other may refer that at least one intervening structure (or intervening layer, or intervening component, or intervening substrate, or intervening interval) exists between the two structures, a lower surface of one of the two structure is adjacent or directly connected with an upper surface of the intervening structure, and an upper surface of the other of the two structures is adjacent or directly connected with a lower surface of the intervening structure. The intervening structure may be a single-layer or multi-layer physical structure or a non-physical structure, and the present disclosure is not limited thereto. In the present disclosure, when a certain structure is disposed “on/above” other structures, it may refer that the certain structure is “directly” disposed on/above the other structures, or the certain structure is “indirectly” disposed on/above the other structures, i.e., at least one structure is disposed between the certain structure and the other structures.

The terms “about”, “equal”, “identical/the same”, or “substantially/approximately” mentioned in this document generally mean being within 20% of a given value or range, or being within 10%, 5%, 3%, 2%, 1% or 0.5% of the given value or range.

Furthermore, any two values or directions used for comparison may have a certain error. If a first value is equal to a second value, it implies that there may be an error of about 10% between the first value and the second value; if a first direction is perpendicular or “substantially” perpendicular to a second direction, then an angle between the first direction and the second direction may be between 80 degrees to 100 degrees; if the first direction is parallel or “substantially” parallel to the second direction, an angle between the first direction and the second direction may be between 0 degree to 10 degrees.

Although ordinal numbers such as “first”, “second”, etc., may be used to describe elements in the description and the claims, it does not imply and represent that there have other previous ordinal number. The ordinal numbers do not represent the order of the elements or the manufacturing order of the elements. The ordinal numbers are only used for discriminate an element with a certain designation from another element with the same designation. The claims and the description may not use the same terms. Accordingly, a first element in the description may be a second element in the claims.

In addition, the term “a given range is from a first value to the second value” or “a given range falls within a range from a first value to a second value” refers that the given range includes the first value, the second value and other values therebetween.

Moreover, the electronic device of the present disclosure may include a display device, a backlight device, an antenna device, a sensing device, a tiled device, a touch display device, a curved display device or a free shape display device, but not limited thereto. The electronic device may exemplarily include liquid crystal, light emitting diode, fluorescence, phosphor, other suitable display media or a combination thereof, but not limited thereto. The display device may be a non-self-luminous type display device or a self-luminous type display device. The antenna device may be a liquid-crystal-type antenna device or a non-liquid-crystal-type antenna device. The sensing device may be a device for sensing capacitance, light, thermal or ultrasonic, but not limited thereto. The electronic components of the electronic device may include passive components and active components, such as capacitors, resistors, inductors, diodes, transistors, etc., but not limited thereto. The diode may include a light emitting diode (LED) or a photodiode. The light emitting diode may include organic light emitting diode (OLED), mini LED, micro LED or quantum dot LED, but not limited thereto. The tiled device may exemplarily be a tiled display device or a tiled antenna device, but not limited thereto. Furthermore, the electronic device may be any combination of aforementioned devices, but not limited thereto. Furthermore, the electronic devices may be foldable or flexible electronic devices. The electronic device may be any combination of aforementioned devices, but not limited thereto. Furthermore, a shape of the electronic device may be a rectangle, a circle, a polygon, a shape with curved edge or other suitable shape. The electronic device may have peripheral systems, such as a driving system, a control system, a light system, etc., for supporting the display device, the antenna device, the wearable device (for example, including augmented reality or virtual reality), the vehicle-mounted device (for example, including car windshields) or the tiled device.

In the present disclosure, it should be understood that a depth, a thickness, a width or a height of each element, or a space or a distance between elements may be measured by an optical microscopy (OM), a scanning electron microscope (SEM), a film thickness profiler (α-step), an ellipsometer or other suitable methods. In some embodiments, a cross-sectional image including elements to be measured can be obtained by the SEM, and the depth, the thickness, the width or the height of each element, or the space or the distance between elements can be measured thereby.

It should be noted that the technical features in different embodiments described in the following can be replaced, recombined, or mixed with one another to constitute another embodiment without departing from the spirit of the present disclosure.

Unless otherwise defined, all terms (including technical and scientific terms) used herein have the same meaning as commonly understood by a person having ordinary skill in the art to which the disclosure belongs. It can be understood that these terms, such as those defined in commonly used dictionaries, should be interpreted as having meanings consistent with the background or context of the related technology and the present disclosure, and should not be interpreted in an idealized or overly formal manner, unless otherwise specified in the disclosed embodiments.

In the present disclosure, the following drawings are described in conjunction with the XYZ Cartesian coordinate system for the sake of convenience. In the present disclosure, the terms such as “space” or “distance” between elements and “width” or “length” of the element are defined by the projection of the element on the XY plane, YZ plane or XZ plane along the X direction, the Y direction or the Z direction. Similarly, terms such as “parallel” or “non-parallel” used herein refers to the projections of the extending lines of the elements on the XY plane, the YZ plane, or the XZ plane are “parallel” or “non-parallel”.

In the present disclosure, one element “overlaps” another element refers that at least of a portion of the element overlaps at least a portion of the another element along a direction.

In the present disclosure, a spacer may be an island or a portion with a larger thickness or height in a layer. A top surface of the spacer may be a flat surface, but not limited thereto. In some embodiments, the top surface of the spacer may be a non-flat surface, such as a curved surface which protrudes upwardly.

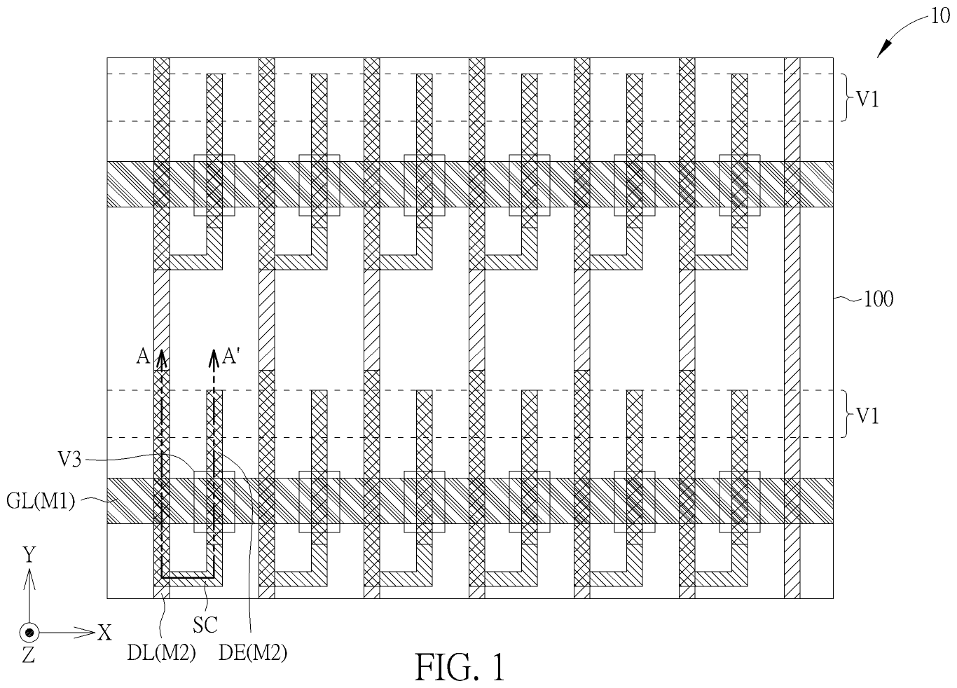

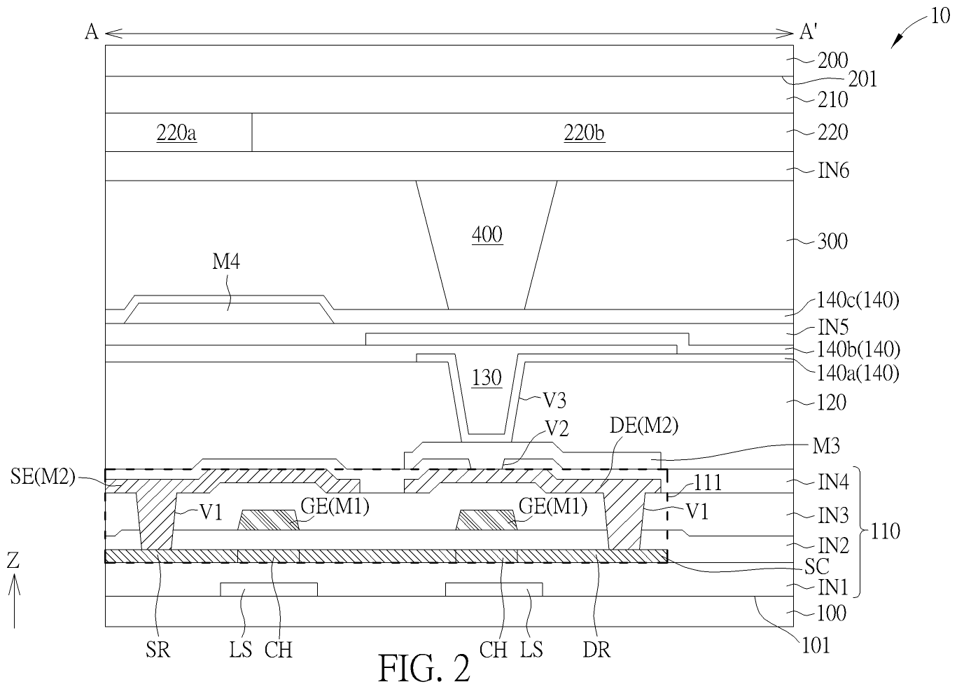

Please refer to FIG. 1 and FIG. 2, FIG. 1 is a schematic diagram showing a top view of an electronic device 10 according to an embodiment of the present disclosure, and FIG. 2 is a schematic diagram showing a partial cross-sectional view taken along line A-A′ of the electronic device 10 shown in FIG. 1. In the embodiment, the electronic device 10 is applied as a display device, but not limited thereto. The electronic device 10 may also include other functions, such as touch and detection, but not limited thereto. In some embodiments, the electronic device 10 may include a virtual reality electronic device. Herein, the electronic device 10 is exemplary a flat electronic device, but not limited thereto. In other embodiments of the present disclosure, the electronic device 10 may be a non-flat electronic device such as a curved electronic device.

The electronic device 10 may include a substrate 100, a thin-film transistor 111, a first organic layer 120, a transparent conductive layer 140, a second organic layer 130 and a spacer 400. The thin-film transistor 111 is disposed on the substrate 100. The first organic layer 120 is disposed on the thin-film transistor 111 and has a via V3. The transparent conductive layer 140 is disposed on the first organic layer 120 and is electrically connected to the thin-film transistor 111 through the via V3. The transparent conductive layer 140 may include, for example, a first transparent conductive layer 140a, a second transparent conductive layer 140b and a third transparent conductive layer 140c, but not limited thereto. The second organic layer 130 is at least partially disposed in the via V3. The spacer 400 is disposed on the second organic layer 130, in which the spacer 400 and the second organic layer 130 at least partially overlap each other. With the second organic layer 130 being at least partially disposed in the via V3, the surface undulation caused by the first organic layer 120 formed with the via V3 can be reduced. Accordingly, it is beneficial for the uppermost film layer on the substrate 100 (herein, the third transparent conductive layer 140c) to provide a flat surface to abut against the spacer 400, such that the stability for supporting the cell gap can be improved.

Specifically, the electronic device 10 may include a substrate 100 and an opposite substrate 200, and the opposite substrate 200 is disposed corresponding to the substrate 100. In some embodiments, the electronic device 10 may further include a display medium layer 300 disposed between the substrate 100 and the opposite substrate 200. For example, the display medium layer 300 is a liquid crystal layer, but not limited thereto. In some embodiments, the electronic device 10 may further include a sealant layer (not shown) disposed between the substrate 100 and the opposite substrate 200. The sealant layer may be used to bond the substrate 100 and the opposite substrate 200, so as to encapsulate the display medium layer 300 between the substrate 100 and the opposite substrate 200.

The electronic device 10 may include a circuit layer 110 disposed on the surface 101 of the substrate 100. The circuit layer 110 may include a patterned light shielding layer LS, an insulating layer IN1, a patterned semiconductor layer SC, an insulating layer IN2, a patterned first metal layer M1, an insulating layer IN3, a patterned second metal layer M2 and an insulating layer IN4 from bottom to top. The light shielding layer LS may be disposed on the surface 101 of the substrate 100. The insulating layer IN1 may be disposed on the light shielding layer LS. The semiconductor layer SC may be disposed on the insulating layer IN1. The semiconductor layer SC may include a drain region DR and a source region SR doped with dopants, and a channel region CH located between the drain region DR and the source region SR. The channel region CH may be disposed substantially corresponding to the gate electrode GE. The insulating layer IN2 is disposed on the semiconductor layer SC and may be configured as the gate dielectric layer of the thin-film transistor 111. The first metal layer M1 is disposed on the insulating layer IN2. The first metal layer M1 may be formed into a plurality of gate lines GL (as shown in FIG. 1). A portion of the gate line GL may be configured as the gate electrode GE of the thin-film transistor 111. The insulating layer IN3 may be disposed on the first metal layer M1. The second metal layer M2 may be disposed on the insulating layer IN3. The second metal layer M2 may be formed into a plurality of data lines DL and a plurality of drain electrodes DE (as shown in FIG. 1). A portion of the data line DL may be configured as the source electrode SE of the thin-film transistor 111. The insulating layer IN2 and the insulating layer IN3 may be formed with a plurality of vias V1. The source electrode SE and the drain electrode DE may be electrically connected to the source region SR and the drain region DR through the vias V1, respectively. The insulating layer IN4 may be disposed on the second metal layer M2. The thin-film transistor 111 may include the semiconductor layer SC, the gate electrode GE, the source electrode SE and the drain electrode DE. Moreover, the thin-film transistor 111 may serve as a driving element. In FIG. 1, the gate line GL extends along the direction X, the data line DL extends along the direction Y and intersects with the gate line GL, the positions of the vias V1 are shown by dotted lines, and the vias V1 extends along the direction X, but not limited thereto. For example, in some embodiments, the extending direction of the data line DL and the extending direction of the gate line GL may not be perpendicular to each other.

The electronic device 10 may include a third metal layer M3. The third metal layer M3 is disposed on the circuit layer 110 corresponding to the drain electrode DE, for example, disposed on the insulating layer IN4 of the circuit layer 110. The third metal layer M3 is disposed between the drain electrode DE and the via V3. The insulating layer IN4 may be formed with a via V2, and the third metal layer M3 is electrically connected to the drain electrode DE through the via V2.

The first organic layer 120 is disposed on the third metal layer M3 and the circuit layer 110. The first organic layer 120 may be formed with the via V3. A portion of the first transparent conductive layer 140a is disposed in the via V3. The first transparent conductive layer 140a is electrically connected to the third metal layer M3. Thereby, the third metal layer M3 can provide a larger area to contact the transparent conductive layer 140 (such as the first transparent conductive layer 140a). When the contact area is larger, the electron transport amount is higher, which is beneficial to improve and stabilize the electron transport between the transparent conductive layer 140 and the drain electrode DE, and reduce the resistance between the transparent conductive layer 140 and the drain electrode DE. Accordingly, the display quality can be improved. In the embodiment, the first transparent conductive layer 140a is electrically connected to the drain electrode DE through the third metal layer M3. In some embodiments, the electronic device 10 may not include the third metal layer M3, and the first transparent conductive layer 140a may be electrically connected to the drain electrode DE directly.

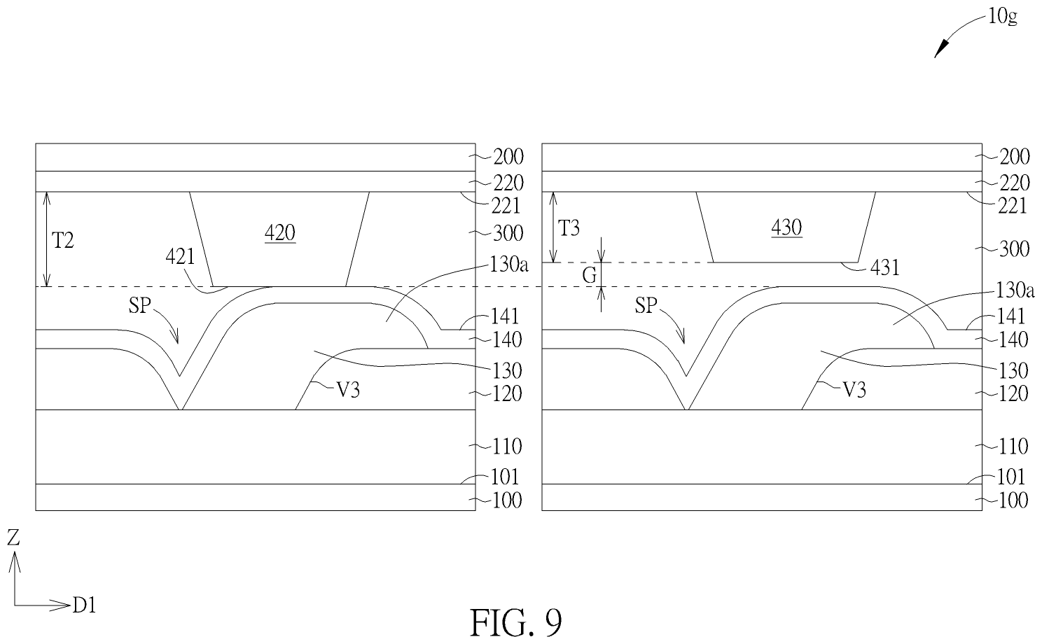

The second organic layer 130 may be at least partially disposed in the via V3, and the second organic layer 130 may completely fill the via V3, but not limited thereto. In some embodiments, the second organic layer 130 may only fill a portion of the via V3 (see FIG. 9 to FIG. 11). It should be noted that when the second organic layer 130 disposed on the first organic layer 120 fills in the via V3, the uneven terrain caused by the via V3 can reduced, thereby display problems, such as light leakage or contrast reduction caused by the poor arrangement of the display medium (such as liquid crystal), may be reduced. Furthermore, the occurrence of damage or breakage of the transparent conductive layer 140a, the transparent conductive layer 140b and/or the insulating layer IN5 due to the uneven terrain can be reduced. Accordingly, the occurrence of short circuit or open circuit may be reduced.

The second transparent conductive layer 140b may be electrically connected to the thin-film transistor 111/drain electrode DE through the first transparent conductive layer 140a and the third metal layer M3. The second transparent conductive layer 140b, for example, may be a pixel electrode. The insulating layer IN5 is disposed on the second transparent conductive layer 140b and the second organic layer 130.

The electronic device 10 may include a fourth metal layer M4, and the fourth metal layer M4 corresponding to the data line DL and/or the gate line GL is disposed on the insulating layer IN5. The third transparent conductive layer 140c is disposed on the fourth metal layer M4 and the insulating layer IN5. Thereby, the fourth metal layer M4 can reduce the impedance of the transparent conductive layer 140 (such as the third transparent conductive layer 140c), and/or can improve the visual visibility problems caused by metal reflection, can reduce the probability of light entering into the semiconductor layer SC, or can increase the opening rate of electronic device 10. The third transparent conductive layer 140c, for example, may be a common electrode.

A light shielding layer 210, a color filter layer 220, an insulating layer IN6 may be formed on the surface 201 of the opposite substrate 200 from top to bottom. The light shielding layer 210 may include a light shielding material, such as a black matrix, but not limited thereto. The light shielding layer 210 may include a plurality of openings (not shown). The color filter layer 220, for example, may include photoresist layers having different colors formed by photoresist materials. For example, the color filter layer 220 may include a red photoresist layer 220a, a blue photoresist layer 220b and/or a green photoresist layer (not shown).

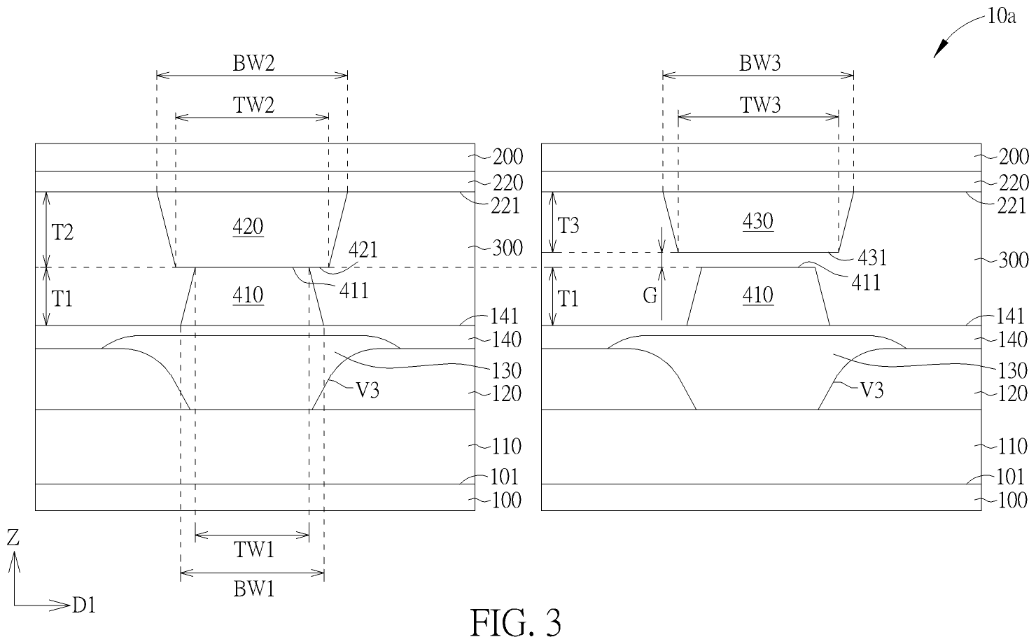

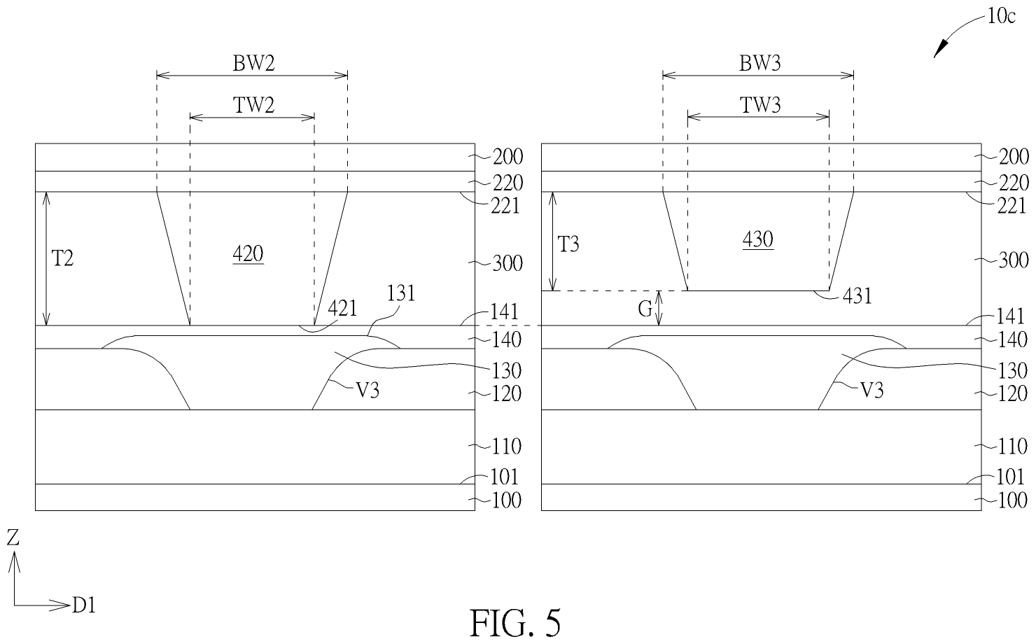

The electronic device 10 may further include a spacer 400. Herein, the spacer 400 is disposed on the insulating layer IN6. In some embodiments, the spacer 400 may be a single spacer. For example, as shown in the embodiment of FIG. 5, the spacer 400 may be the second spacer 420. In some embodiments, the spacer 400 may include a plurality of spacers. For example, as shown in the embodiment of FIG. 3, the spacer 400 may include a first spacer 410 and a second spacer 420.

In some embodiments, at least parts of the layers and/or elements on the opposite substrate 200 may be disposed on the substrate 100, but not limited thereto. In addition, one side of the electronic device 10 may be disposed with a backlight element (not shown). For example, the backlight element may be disposed below the substrate 100. The backlight element may include light emitting diodes (LEDs), submillimeter light emitting diodes (mini LEDs), micro light emitting diodes (micro LEDs), quantum dots (QDs), quantum dot light emitting diodes (QLEDs, QD-LEDs), fluorescence, phosphor, other suitable materials, or a combination thereof, but not limited thereto.

The substrate 100 and the opposite substrate 200 may exemplary be flexible or inflexible substrates. The substrate 100 and the opposite substrate 200 may be transparent substrates, and the materials thereof may exemplarily include glass, quartz, sapphire, polyimide (PI), polycarbonate (PC), polyethylene terephthalate (PET), other suitable materials or a combination thereof, but not limited thereto. The material of the light shielding layer LS may exemplarily include metal. The materials of the insulating layer IN1, the insulating layer IN2, the insulating layer IN3, the insulating layer IN4 and the insulating layer IN5, for example, may include inorganic materials (such as silicon oxide, silicon nitride, silicon oxynitride, or stacking layers including at least two of the aforementioned materials). The material of the insulating layer IN6, for example, may include but not limited to, transparent organic materials, such as photoresist materials. The material of the semiconductor layer SC may include, for example, amorphous silicon, low temperature polysilicon (LTPS), metal oxides (such as indium gallium zinc oxide (IGZO)), other suitable materials or a combination thereof. The materials of the first metal layer M1, the second metal layer M2, the third metal layer M3 and the fourth metal layer M4, for example, may include metal materials. The metal materials may include, for example, aluminum, molybdenum, copper, titanium, other suitable materials or a combination of at least two thereof, but not limited thereto. The materials of the first organic layer 120, the second organic layer 130 and the spacer 400 may include, for example, organic materials (such as photoresist materials, polyimide resin, epoxy resin, acrylic resin, other suitable materials or a combination thereof), or may include low-reflective metal or inorganic materials when electricity or material hardness are required, but not limited thereto. The material of the transparent conductive layer 140 may include, for example, indium tin oxide (ITO), but not limited thereto.

For the sake of simplification, FIG. 1 mainly shows the substrate 100, the semiconductor layers SC, the gate lines GL, the data lines DL and the drain electrodes DE of the electronic device 10, and the positions of the vias V1 and the vias V3, and other elements of the electronic device 10 are omitted.

In addition to the above elements and/or film layers, the electronic device 10 of the embodiment may also include other suitable elements and/or film layers according to design requirements.

Please refer to FIG. 3, which is a schematic diagram showing a partial cross-sectional view of an electronic device 10a according to another embodiment of the present disclosure. The left half part and the right half part in FIG. 3 are partial cross-sectional views respectively correspond to the electronic device 10a where the second spacer 420 and the third spacer 430 are disposed. As shown in the left half part of FIG. 3, the electronic device 10a may include a substrate 100, a circuit layer 110, a first organic layer 120, a second organic layer 130, a transparent conductive layer 140, a first spacer 410 and a second spacer 420, in which the circuit layer 110 is disposed on the surface 101 of the substrate 100 and is disposed with a thin-film transistor (not shown). That is, the thin-film transistor is disposed on the substrate 100. For details of the thin-film transistor and the circuit layer 110, reference may be made to the relevant description of the thin-film transistor 111 and the circuit layer 110 shown in FIG. 2, and are not repeated herein. The first organic layer 120 is disposed on the thin-film transistor and has a via V3. The transparent conductive layer 140 is disposed on the first organic layer 120 and is electrically connected to the thin-film transistor through the via V3. The second organic layer 130 is at least partially disposed in the via V3. The first spacer 410 is disposed on the second organic layer 130, and the second spacer 420 is disposed on the first spacer 410, in which the second organic layer 130, the first spacer 410 and the second spacer 420 at least partially overlap with each other. The aforementioned “the second organic layer 130, the first spacer 410 and the second spacer 420 at least partially overlap with each other” may refer that in the top view of the electronic device 10a (for example, viewing the electronic device 10a along a direction opposite to a normal direction (i.e., the direction Z) of the surface 101 of the substrate 100), at least a portion of the second organic layer 130, at least a portion of the first spacer 410 and at least a portion of the second spacer 420 overlap each other. With the second organic layer 130 being disposed between the first organic layer 120 and the transparent conductive layer 140, the surface undulation caused by the first organic layer 120 formed with the via V3 can be reduced. By disposing the first spacer 410, a flat surface can be provided by the first spacer 410 to abut against the second spacer 420, so as to reduce the thickness T2 of the second spacer 420 while maintaining the same cell gap, which is beneficial to reduce the process variation. In addition, when the electronic device 10a is applied to liquid crystal display devices, after the desired film layers are formed on the substrate 100 and the opposite substrate 200, alignment films (not shown) will be coated on the inner sides of the substrate 100 and the opposite substrate 200. The material of the alignment films, for example, may include polyimide (PI). With the first spacer 410 being configured with a lower thickness T1 and/or the second spacer 420 being configured with a lower thickness T2, the probability of poor liquid crystal alignment can be reduced, so as to reduce the phenomenon of light leakage.

In the embodiment, the transparent conductive layer 140 is disposed between the second organic layer 130 and the first spacer 410. For example, the transparent conductive layer 140 may be the second transparent conductive layer 140b or the third transparent conductive layer 140c, or a composite structure formed by the second transparent conductive layer 140b, the third transparent conductive layer 140c and the insulating layer IN5 shown in FIG. 2, but not limited thereto. With the transparent conductive layer 140 being disposed on the second organic layer 130, for example, the exposed energy for the transparent conductive layer 140 when patterning the transparent conductive layer 140 can be more uniform. In some embodiments, the transparent conductive layer 140 may be disposed between the first organic layer 120 and the second organic layer 130. For example, the transparent conductive layer 140 may be the first transparent conductive layer 140a shown in FIG. 2.

The electronic device 10a may further include a display medium layer 300, a color filter layer 220 and an opposite substrate 200. Although not shown in the drawing, other details of the electronic device 10a may be the same as that of the electronic device 10 shown in FIG. 2. For example, the electronic device 10a may also include a third metal layer M3, a first transparent conductive layer 140a disposed between the first organic layer 120 and the second organic layer 130, a fourth metal layer M4, an insulating layer IN6, a light shielding layer 210, etc. For details for the aforementioned elements, reference may be made to the relevant description of FIG. 2.

Specifically, the second organic layer 130, for example, may completely fill the via V3, the first spacer 410 may be formed on the substrate 100, such as on the transparent conductive layer 140 on the substrate 100. The second spacer 420 may be formed on the opposite substrate 200, such as on the color filter layer 220 or the insulating layer IN6 (see FIG. 2). Then the side of the opposite substrate 200 formed with the second spacer 420 is faced toward the side of the substrate 100 formed with the first spacer 410 and the opposite substrate 200 is assembled with the substrate 100. Thereby, it is beneficial to reduce the thickness T1 of the first spacer 410 and the thickness T2 of the second spacer 420. When the electronic device 10a is applied to liquid crystal display devices, it is beneficial to reduce the phenomenon of light leakage. In the cross-sectional view of the electronic device 10a, a width of the first spacer 410 close to the substrate 100 (such as the bottom width BW1) may be greater than a width of the first spacer 410 close to the second spacer 420 (such as the top width TW1). That is, the width of the first spacer 410 close to the substrate 100 (such as the bottom width BW1) may be greater than the width of first spacer 410 away from the substrate 100 (such as the top width TW1). The width of the first spacer 410 may be configured to vary gradually (herein, decrease gradually) from the substrate 100 along the normal direction (i.e., the direction Z) away from the substrate 100. The width of the second spacer 420 close to the opposite substrate 200 (such as the bottom width BW2) may be greater than the width of the second spacer 420 close to the first spacer 410 (such as the top width TW2). That is, the width of the second spacer 420 close to the opposite substrate 200 (such as the bottom width BW2) may be greater than the width of the second spacer 420 away from the opposite substrate 200 (such as the top width TW2). The width of the second spacer 420 may be configured to vary gradually (herein, decrease gradually) from the opposite substrate 200 along a direction opposite to the normal direction away from the opposite substrate 200. The top width TW2 of the second spacer 420 may be greater than the top width TW1 of the first spacer 410, and the bottom width BW2 of the second spacer 420 may be greater than the bottom width BW1 of the first spacer 410. The thickness T1 of the first spacer 410 and the thickness T2 of the second spacer 420 may be configured so that the top surface 411 of the first spacer 410 and the top surface 421 of the second spacer 420 abut against each other. Thereby, the cell gap can be maintained. The cell gap may be configured to accommodate other elements of the electronic device 10a, such as the display medium layer 300. The thickness T1 of the first spacer 410, for example, may be less than the thickness T2 of the second spacer 420, but not limited thereto. In some embodiments, the thickness T1 of the first spacer 410 may be equal to or greater than the thickness T2 of the second spacer 420. The aforementioned “width” refers to the width of the spacer along the direction D1. The direction D1, for example, is parallel to the direction X or the direction Y. In the present disclosure, the cross-sectional view of the electronic device 10a may be, for example, viewing the electronic device 10a along a direction perpendicular to the normal direction (i.e., the direction Z) of the surface 101 of the substrate 100, such as viewing the electronic device 10a along a direction parallel to the direction X or the direction Y. The aforementioned “thickness” refers to the protruding length or the protruding height of the spacer in the normal direction. For example, the thickness T1 may be the maximum protruding height of the first spacer 410 relative to the top surface 141 of the transparent conductive layer 140 in the normal direction, and the thickness T2 may be the maximum protruding height of the second spacer 420 relative to the surface 221 of the color filter layer 220 in the normal direction.

The main difference between the right half part of FIG. 3 and the left half part of FIG. 3 is that the second spacer 420 is replaced by the third spacer 430. The third spacer 430 may be formed on the opposite substrate 200, such as on the color filter layer 220 or the insulating layer IN6 (see FIG. 2). In the cross-sectional view of the electronic device 10a, the width of the third spacer 430 close to the opposite substrate 200 (such as the bottom width BW3) may be greater than the width of the third spacer 430 close to the first spacer 410 (such as the top width TW3). That is, the width of the third spacer 430 close to the opposite substrate 200 (such as the bottom width BW3) may be greater than the width of the third spacer 430 away from the opposite substrate 200 (such as the top width TW3). The width of the third spacer 430 may be configured to vary gradually (herein, decrease gradually) from the opposite substrate 200 along a direction opposite to the normal direction away from the opposite substrate 200. The top width TW3 of the third spacer 430 may be greater than the top width TW1 of the first spacer 410, and the bottom width BW3 of the third spacer 430 may be greater than the bottom width BW1 of the first spacer 410. The thickness T2 of the second spacer 420 and the thickness T3 of the third spacer 430 may be different. Herein, the thickness T3 of the third spacer 430 may be less than the thickness T2 of the second spacer 420, so that the top surface 411 of the first spacer 410 and the top surface 431 of the third spacer 430 do not abut against each other. That is, there is a gap G between the top surface 411 of the first spacer 410 and the top surface 431 of the third spacer 430. In other words, in the electronic device 10a, the substrate 100 may be disposed with a plurality of spacers with the same thickness (i.e., the first spacers 410), and the opposite substrate 200 may be disposed with a plurality of spacers with different thicknesses (i.e., the second spacer 420 and the third spacer 430). In the embodiment, the two opposite ends of the second spacer 420 (such as the two opposite ends along the direction Z) may contact the film layer on the substrate 100 and the film layer on the opposite substrate 200, respectively. As for the two opposite ends of the third spacer 430 (such as the two opposite ends along the direction Z), one of the two opposite ends may be disposed on (the film layer of) the opposite substrate 200, and the other one of the two opposite ends does not contact the film layer on the substrate 100 when the electronic device 10a is not pressed.

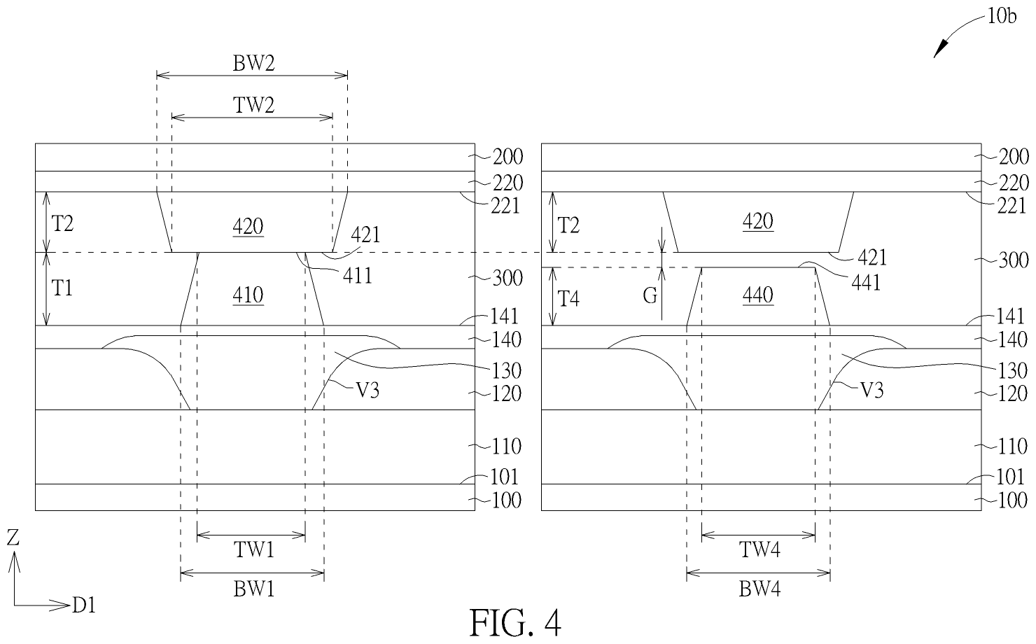

Please refer to FIG. 4, which is a schematic diagram showing a partial cross-sectional view of an electronic device 10b according to further another embodiment of the present disclosure. The main difference between the electronic device 10b shown in FIG. 4 and the electronic device 10a shown in FIG. 3 is that in the electronic device 10b shown in FIG. 4, the substrate 10 may be disposed with a plurality of spacers with different thicknesses (i.e., the first spacer 410 and the fourth spacer 440), and the opposite substrate 200 may be disposed with a plurality of spacers with the same thickness (i.e., the second spacers 420).

Specifically, the first spacer 410 and the fourth spacer 440 may be formed on the substrate 100, such as on the transparent conductive layer 140 on the substrate 100, and the second spacer 420 may be formed on the opposite substrate 200, such as on the color filter layer 220 or the insulating layer IN6 (see FIG. 2). The thickness T1 of the first spacer 410 and the thickness T2 of the second spacer 420 may be configured so that the top surface 411 of the first spacer 410 and the top surface 421 of the second spacer 420 abut against each other. Thereby, the cell gap can be maintained. The thickness T1 of the first spacer 410, for example, may be greater than the thickness T2 of the second spacer 420, but not limited thereto. The thickness T1 of the first spacer 410 and the thickness T4 of the fourth spacer 440 may be different. Herein, the thickness T4 of the fourth spacer 440 may be less than the thickness T1 of the first spacer 410, so that the top surface 441 of the fourth spacer 440 and the top surface 421 of the second spacer 420 do not abut against each other. That is, there is a gap G between the top surface 441 of the fourth spacer 440 and the top surface 421 of the second spacer 420. In the cross-sectional view of the electronic device 10b, the width of the fourth spacer 440 close to the substrate 100 (such as the bottom width BW4) may be greater than the width of the fourth spacer 440 close to the second spacer 420 (such as the top width TW4). The width of the fourth spacer 440 may be configured to vary gradually (herein, decrease gradually) from the substrate 100 along the normal direction away from the substrate 100. The top width TW2 of the second spacer 420 may be greater than the top width TW4 of the fourth spacer 440, and the bottom width BW2 of the second spacer 420 may be greater than the bottom width BW4 of the fourth spacer 440.

Please refer to FIG. 5, which is a schematic diagram showing a partial cross-sectional view of an electronic device 10c according to yet another embodiment of the present disclosure. The main difference between the electronic device 10c shown in FIG. 5 and the electronic device 10a shown in FIG. 3 is that in the electronic device 10c shown in FIG. 5, there is no spacer (such as the first spacer 410 shown in FIG. 3) disposed on the substrate 100. That is, in the electronic device 10c shown in FIG. 5, the substrate 100 is not disposed with spacers, while the opposite substrate 200 is disposed with a plurality of spacers with different thicknesses (such as the second spacer 420 and the third spacer 430).

As shown in the left half part of FIG. 5, the electronic device 10c may include a substrate 100, a circuit layer 110, a first organic layer 120, a second organic layer 130, a transparent conductive layer 140 and a second spacer 420, in which the circuit layer 110 is disposed on the surface 101 of the substrate 100 and is disposed with a thin-film transistor (not shown). That is, the thin-film transistor is disposed on the substrate 100. For details of the thin-film transistor and the circuit layer 110, reference may be made to the relevant description of the thin-film transistor 111 and the circuit layer 110 shown in FIG. 2, and are not repeated herein. The first organic layer 120 is disposed on the thin-film transistor and has a via V3. The transparent conductive layer 140 is disposed on the first organic layer 120 and is electrically connected to the thin-film transistor through the via V3. The second organic layer 130 is at least partially disposed in the via V3. The second spacer 420 is disposed on the second organic layer 130 and overlaps the second organic layer 130. The transparent conductive layer 140 is disposed between the second spacer 420 and the second organic layer 130. In the cross-sectional view of the electronic device 10c, the width of the second spacer 420 close to the second organic layer 130 (such as top width TW2) may be less than the width of the second spacer 420 away from the second organic layer 130 (such as the bottom width BW2). The aforementioned “the second spacer 420 overlaps the second organic layer 130” may refer that in the top view of the electronic device 10c (for example, viewing the electronic device 10c along a direction opposite to a normal direction (i.e., the direction Z) of the surface 101 of the substrate 100), at least a portion of the second spacer 420 and at least a portion of the second organic layer 130 overlap each other. With the second organic layer 130 being disposed between the first organic layer 120 and the transparent conductive layer 140, the surface undulation caused by the first organic layer 120 formed with of the via V3 can be reduced, and it is beneficial for the uppermost film layer on the substrate 100 (herein, the transparent conductive layer 140) to provide a flat surface to butt against the second spacer 420. Furthermore, with the via V3 being filled by the second organic layer 130 before forming the transparent conductive layer 140, it is beneficial to enhance the feasibility of the process. When the electronic device 10c is applied to liquid crystal display devices, it is beneficial to improve the efficiency of liquid crystal.

Specifically, the second spacer 420 and the third spacer 430 may be formed on the opposite substrate 200, such as on the color filter layer 220 or the insulating layer IN6 (see FIG. 2). There is no spacer disposed on the substrate 100. Thereby, the flat area on the opposite side abutted by the second spacer 420 is larger, which is beneficial to improve the support stability. In the cross-sectional view of the electronic device 10c, the width of the second spacer 420 close to the opposite substrate 200 (such as the bottom width BW2) may be greater than the width of the second spacer 420 away from the opposite substrate 200 (such as the top width TW2). The width of the second spacer 420 may be configured to vary gradually (herein, decrease gradually) from the opposite substrate 200 along a direction opposite to the normal direction away from the opposite substrate 200. The width of the third spacer 430 close to the second organic layer 130 (such as the top width TW3) may be less than the width of the third spacer 430 away from the second organic layer 130 (such as bottom width BW3). The width of the third spacer 430 close to the opposite substrate 200 (such as the bottom width BW3) may be greater than the width of the third spacer 430 away from the opposite substrate 200 (such as the top width TW3). The width of the third spacer 430 may be configured to vary gradually (herein, decrease gradually) from the opposite substrate 200 along a direction opposite to the normal direction away from the opposite substrate 200. The thickness T2 of the second spacer 420 may be configured so that the top surface 421 of the second spacer 420 and the surface of the uppermost film layer on the substrate 100 abut against each other. Thereby, the cell gap can be maintained. Herein, the surface of the uppermost film layer on the substrate 100 is exemplary the top surface 141 of the transparent conductive layer 140, but not limited thereto. The thickness T2 of the second spacer 420 and thickness T3 of the third spacer 430 may be different. Herein, the thickness T3 of the third spacer 430 may be less than the thickness T2 of the second spacer 420, so that the top surface 431 of the third spacer 430 does not abut against the surface of the uppermost film layer on the substrate 100 (such as the top surface 141 of the transparent conductive layer 140). That is, there is a gap G between the top surface 431 of the third spacer 430 and the surface of the uppermost film layer on the substrate 100.

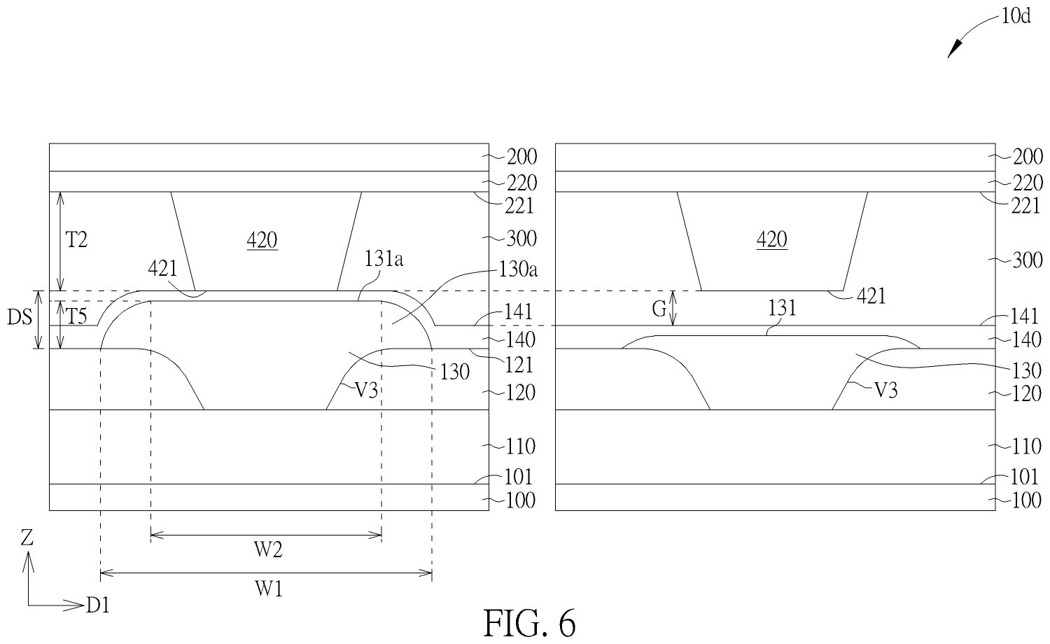

Please refer to FIG. 6, which is a schematic diagram showing a partial cross-sectional view of an electronic device 10d according to yet another embodiment of the present disclosure. The main difference between the electronic device 10d shown in FIG. 6 and the electronic device 10c shown in FIG. 5 is that in the electronic device 10d shown in FIG. 6, the opposite substrate 200 is disposed with a plurality of spacers having the same thickness (i.e. the second spacer 420), and some portions of the second organic layer 130 corresponding to the second spacers 420 are disposed with protruding portions 130a. In other words, the second organic layer 130 includes a plurality of portions corresponding to the second spacers 420, in which some of the plurality of the portions are disposed with the protruding portions 130a, as shown in the left half part of FIG. 6, while the rest of the plurality of the portions are not disposed with the protruding portions 130a, as shown in the right half part of FIG. 6.

Specifically, the second organic layer 130 includes the protruding portions 130a, and the portions of the transparent conductive layer 140 covering the protruding portions 130a abut against the second spacers 420. For example, the protruding portion 130a may be integrally formed on the second organic layer 130. In the cross-sectional view of the electronic device 10d, the width of the protruding portion 130a close to the substrate 100 (such as the width W1) may be greater than the width of the protruding portion 130a away from the substrate 100 (such as the width W2). The width of the protruding portion 130a may be configured to vary gradually (herein, decrease gradually) from the substrate 100 along the normal direction away from substrate 100. The thickness T5 of the protruding portion 130a may be configured so that the top surface 421 of the second spacer 420 and the surface of the uppermost film layer on the substrate 100 (such as the top surface 141 of the transparent conductive layer 140) abut against each other. Thereby, the cell gap can be maintained. The maximum distance DS between the top surface 141 of the transparent conductive layer 140 and the top surface 121 of the first organic layer 120 (the surface of the flat portion of the first organic layer 120) may be equal to the thickness T2 of the second spacer 420. Thereby, the requirement of the process thickness limit of the material can be met, and it is beneficial to reduce the phenomenon of light leakage caused by excessive undulation of the film layer. The thickness T5 of the aforementioned protruding portion 130a may be the maximum protruding height of the protruding portion 130a relative to the top surface 121 of the first organic layer 120 in the normal direction, or may be the height difference between the top surface 131a of the protruding portion 130a and the top surface 121 of the first organic layer 120 in the normal direction.

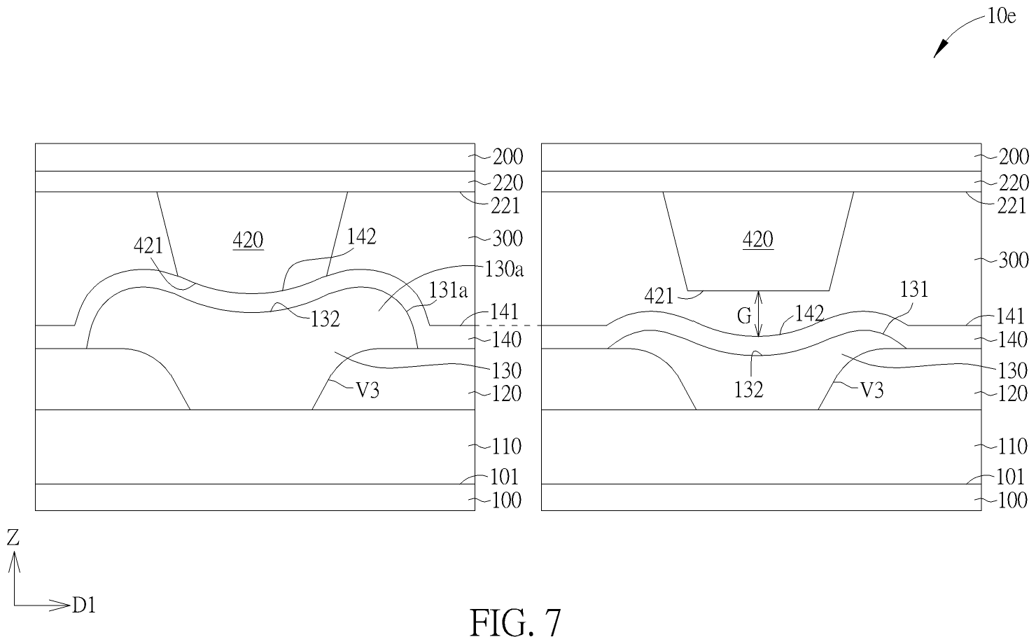

Please refer to FIG. 7, which is a schematic diagram showing a partial cross-sectional view of an electronic device 10e according to yet another embodiment of the present disclosure. The main difference between the electronic device 10e shown in FIG. 7 and the electronic device 10d shown in FIG. 6 is that in the electronic device 10e shown in FIG. 7, the top surface 131a of the protruding portion 130a includes a first recessed portion 132. Correspondingly, the top surface 141 of the transparent conductive layer 140 includes a second recessed portion 142, and the top surface 421 of the second spacer 420 is correspondingly embedded into the second recessed portion 142 of the transparent conductive layer 140. Thereby, the probability that the second spacer 420 displaces relative to the transparent conductive layer 140 and the second organic layer 130 along the direction D1 (such as the direction X or the direction Y) can be reduced, which can improve the stability for supporting the cell gap. As shown in the right half part of FIG. 7, the portion of the second organic layer 130 corresponding to the second spacer 420 without the protruding portion 130a may also include the first recessed portion 132. Correspondingly, the top surface 141 of the transparent conductive layer 140 corresponding to the first recessed portion 132 may be formed with the second recessed portion 142, but not limited thereto. Furthermore, before assembling the substrate 100 and the opposite substrate 200, the second spacer 420 located at the left half part of FIG. 7 may have a flat surface (see the second spacer 420 at the right half part of FIG. 6). During the process of assembling the substrate 100 and the opposite substrate 200, the second spacer 420 and the transparent conductive layer 140 in the left half part of FIG. 7 abut against each other, so that the second spacer 420 is deformed to embed into the second recessed portion 142 of the transparent conductive layer 140 correspondingly. In the embodiment, the first recessed portion 132 is formed on the protruding portion 130a of the second organic layer 130, which is exemplary and the present disclosure in not limited thereto. For example, in the left half part of FIG. 5, the top surface 131 of the second organic layer 130 corresponding to the second spacer 420 may be formed with a first recessed portion (not shown), and the top surface 141 of the transparent conductive layer 140 may be correspondingly formed with a second recessed portion (not shown). The top surface 421 of the second spacer 420 is correspondingly embedded into the second recessed portion of the transparent conductive layer 140, which is also beneficial to reduce the probability that the second spacer 420 displaces relative to the transparent conductive layer 140 and the second organic layer 130 along the direction D1 (such as the direction X or the direction Y). In the right half part of FIG. 5, the top surface 131 of the second organic layer 130 corresponding to the third spacer 430 may also be formed with a first recessed portion (not shown), and the top surface 141 of the transparent conductive layer 140 may be correspondingly formed with a second recessed portion (not shown), but the present disclosure is not limited thereto. In other words, the configuration of the second organic layer 130 formed with the first recessed portion 132 and the transparent conductive layer 140 formed with the second recessed portion 142 shown in FIG. 7 may be applied to other embodiments of the present disclosure.

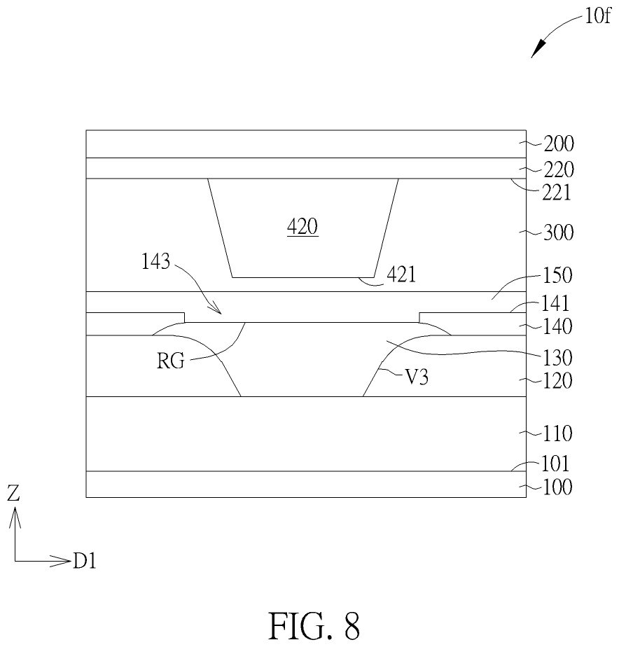

Please refer to FIG. 8, which is a schematic diagram showing a partial cross-sectional view of an electronic device 10f according to yet another embodiment of the present disclosure. FIG. 8 only shows the part corresponding to the right half part of FIG. 6. The main difference between the electronic device 10f shown in FIG. 8 and the electronic device 10d shown in FIG. 6 is that in the electronic device 10f shown in FIG. 8, the transparent conductive layer 140 includes a hollow portion 143, and the hollow portion 143 overlaps the second spacer 420. The aforementioned “the hollow portion 143 overlaps the second spacer 420” may refer that in a top view of the electronic device 10f, at least a portion of the hollow portion 143 and at least a portion of the second spacer 420 overlap each other. Specifically, the portion of the transparent conductive layer 140 corresponding to the second spacer 420 may be formed with a hollow portion 143. The region RG of the second organic layer 130 corresponding to the hollow portion 143 and not covered by the transparent conductive layer 140 corresponds to (or overlaps) the second spacer 420. Thereby, when the second spacer 420 and the uppermost film layer on the substrate 100 (herein, the protection layer 150) abut against each other, the probability that the transparent conductive layer 140 is damaged to form broken bright spots may be reduced. The electronic device 10f may further include a protection layer 150. The protection layer 150 is disposed on the second organic layer 130 and the transparent conductive layer 140, and covers the second organic layer 130 and the transparent conductive layer 140. The material of the protection layer 150, for example, may include silicon nitrides (SiNx). The protection layer 150 can provide further protection for the transparent conductive layer 140, but not limited thereto. In some embodiments, the protection layer 150 may be omitted. Although not shown in the drawing, in the part of the electronic device 10f corresponding to the left half part of FIG. 6, the transparent conductive layer 140 disposed on the protruding portion 130a may be formed with a hollow portion 143 at the position corresponding to the second spacer 420. The region RG (of the protruding portion 130a) of the second organic layer 130 corresponding to the hollow portion 143 and not covered by the transparent conductive layer 140 corresponds to (or overlaps) the second spacer 420, and (the protruding portion 130a of) the second organic layer 130 may abut against the second spacer 420 through the protection layer 150. Furthermore, the configuration of the transparent conductive layer 140 including the hollow portion 143 may also be applied to other embodiments of the present disclosure, and the configuration of the electronic device 10f further including the protection layer 150 may also be applied to other embodiments of the present disclosure.

Please refer to FIG. 9, which is a schematic diagram showing a partial cross-sectional view of an electronic device 10g according to yet another embodiment of the present disclosure. The main difference between the electronic device 10g shown in FIG. 9 and the electronic device 10c shown in FIG. 5 is that in the electronic device 10g shown in FIG. 9, the second organic layer 130 fills the via V3 incompletely, so that there is an unfilled space SP in the via V3. The portions of the second organic layer 130 corresponding to the second spacer 420 and the third spacer 430 may be respectively disposed with the protruding portions 130a. With the second organic layer 130 filling the via V3 incompletely, it is beneficial to reduce the difficulty of the process. Specifically, the opposite substrate 200 is disposed with a plurality of spacers with different thicknesses (i.e., the second spacer 420 and the third spacer 430). The thickness T2 of the second spacer 420 may be configured so that the top surface 421 of the second spacer 420 and the surface of the uppermost film layer on the substrate 100 abut against each other. Thereby, the cell gap can be maintained. Herein, the surface of the uppermost film layer on the substrate 100 is the top surface 141 of the transparent conductive layer 140, which is exemplary and the present disclosure is not limited thereto. The thickness T3 of the third spacer 430 may be less than the thickness T2 of the second spacer 420, so that the top surface 431 of the third spacer 430 and the surface of the uppermost film layer on the substrate 100 (such as the top surface 141 of the transparent conductive layer 140) do not abut against each other. That is, there is a gap G between the top surface 431 of the third spacer 430 and the surface of the uppermost film layer on the substrate 100.

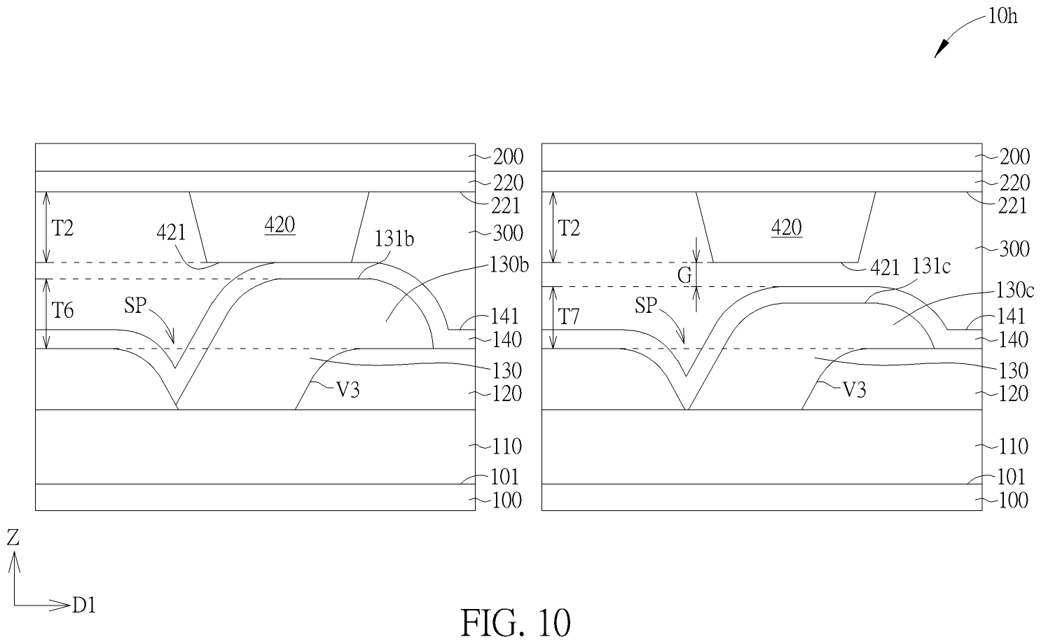

Please refer to FIG. 10, which is a schematic diagram showing a partial cross-sectional view of an electronic device 10h according to yet another embodiment of the present disclosure. The main difference between the electronic device 10h shown in FIG. 10 and the electronic device 10g shown in FIG. 9 is that in the electronic device 10h shown in FIG. 10, the opposite substrate 200a is disposed with a plurality of spacers with the same thickness (i.e., the second spacers 420), and the second organic layer 130 includes a first protruding portion 130b corresponding to one of the second spacers 420 and a second protruding portion 130c corresponding to another one of the second spacers 420. The thickness T6 of the first protruding portion 130b may be greater than the thickness T7 of the second protruding portion 130c. The thickness T6 of the first protruding portion 130b may be configured so that the top surface 421 of the second spacer 420 and the surface of the uppermost film layer on the substrate 100 (such as the top surface 141 of the transparent conductive layer 140) abut against each other. Thereby, the cell gap can be maintained. The thickness T7 of the second protruding portion 130c may be configured so that the top surface 421 of the second spacer 420 and the surface of the uppermost film layer on the substrate 100 (such as the top surface 141 of the transparent conductive layer 140) do not abut against each other. That is, there is a gap G between the top surface 421 of the second spacer 420 and the portion of the surface of the uppermost film layer on the substrate 100 (such as the top surface 141 of the transparent conductive layer 140) covering the second protruding portion 130c.

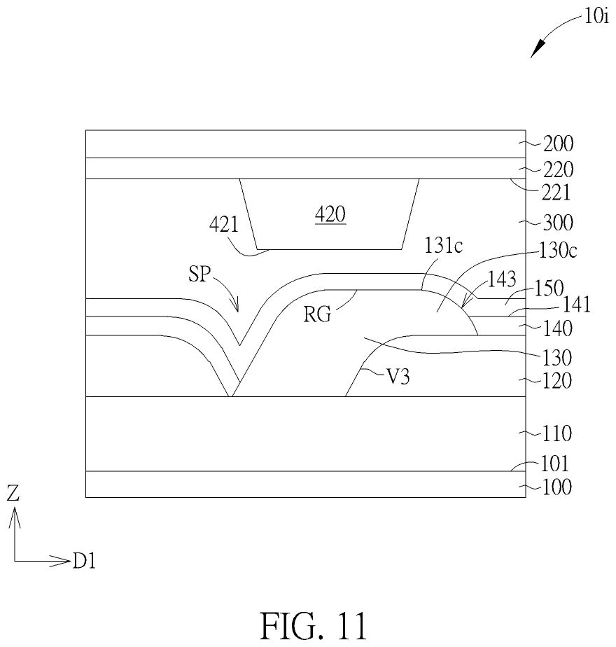

Please refer to FIG. 11, which is a schematic diagram showing a partial cross-sectional view of an electronic device 10i according to yet another embodiment of the present disclosure. FIG. 11 only shows the part of the electronic device 10i corresponding to the right half part of FIG. 10. The main difference between the electronic device 10i shown in FIG. 11 and the electronic device 10h shown in FIG. 10 is that in the electronic device 10i shown in FIG. 11, the transparent conductive layer 140 includes a hollow portion 143, and the hollow portion 143 overlaps the second spacer 420. Specifically, the portion of the transparent conductive layer 140 corresponding to the second spacer 420 may be formed with the hollow portion 143. The region RG of the second organic layer 130 corresponding to the hollow portion 143 and not covered by the transparent conductive layer 140 corresponds to (or overlaps) the second spacer 420. The region RG of the second organic layer 130 not covered by the transparent conductive layer 140 includes the top surface 131c of the second protruding portion 130c. Thereby, when the second spacer 420 and the uppermost film layer on the substrate 100 (herein, the protection layer 150) abut against each other, the probability that the transparent conductive layer 140 is damaged to form broken bright spots may be reduced. The electronic device 10i may further include a protection layer 150, which is disposed on the second organic layer 130 and the transparent conductive layer 140 and covers the second organic layer 130 and the transparent conductive layer 140. For details of the protection layer 150, reference may be made to the above description and are not repeated herein. In some embodiments, the protection layer 150 may be omitted. Although not shown in the drawing, in the part of the electronic device 10i corresponding to the left half part of FIG. 10, the transparent conductive layer 140 disposed on the first protruding portion 130b may be formed with a hollow portion 143 at the position corresponding to the second spacer 420. The region RG (of the first protruding portion 130b) of the second organic layer 130 corresponding to the hollow portion 143 and not covered by the transparent conductive layer 140 corresponds to (or overlaps) the second spacer 420. The region RG of the second organic layer 130 not covered by the transparent conductive layer 140 includes the top surface 131b of first protruding portion 130b, and (the first protruding portion 130b of) the second organic layer 130 may abut against the second spacer 420 through the protection layer 150.

According to the present disclosure, with the second organic layer being at least partially disposed in the via V3, and the second organic layer at least partially overlapping the spacer, the surface undulation caused by the first organic layer formed with the via V3 can be reduced. Accordingly, it is beneficial to provide a flat surface to abut against the spacer, such that the stability for supporting the cell gap can be improved. When the electronic device is applied to liquid crystal display devices, the phenomenon that the arrangement of liquid crystal is affected by the undulation of film layers may be reduced, which is beneficial to the application of high-resolution electronic devices. In the present disclosure, the spacer may be formed on the opposite substrate. With the second organic layer being at least partially disposed in the via of the first organic layer, it is beneficial for the uppermost film layer on the substrate to provide a flat surface to butt against the spacer. Alternatively, the spacers may include a first spacer formed on the substrate and a second spacer formed on the opposite substrate. With the second organic layer being at least partially disposed in the via of the first organic layer, it is beneficial for the first spacer to provide a flat surface to abut against the second spacer, and can reduce the thickness of the first spacer and the thickness of second spacer while maintaining the cell gap. Accordingly, it is beneficial to reduce the process variation.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a substrate;
a thin-film transistor disposed on the substrate;
a first organic layer disposed on the thin-film transistor and having a via;
a transparent conductive layer disposed on the first organic layer and electrically connected to the thin-film transistor through the via;
a second organic layer at least partially disposed in the via;
a first spacer disposed on the second organic layer; and
a second spacer disposed on the first spacer, wherein the second organic layer, the first spacer and the second spacer at least partially overlap each other.

2. The electronic device of claim 1, further comprising:
an opposite substrate disposed corresponding to the substrate, wherein in a cross-sectional view of the electronic device, a first width of the second spacer close to the opposite substrate is greater than a second width of the second spacer close to the first spacer.

3. The electronic device of claim 1, wherein the transparent conductive layer is disposed between the first organic layer and the second organic layer.

4. The electronic device of claim 1, wherein the transparent conductive layer is disposed between the second organic layer and the first spacer.

5. The electronic device of claim 1, wherein in a cross-sectional view of the electronic device, a top width of the second spacer is greater than a top width of the first spacer.

6. The electronic device of claim 1, further comprising:
a third spacer disposed on the second organic layer; and
a fourth spacer disposed on the third spacer, wherein the second organic layer, the third spacer and the fourth spacer at least partially overlap each other, the first spacer and the second spacer abut against each other, and there is a gap between the third spacer and the fourth spacer.

7. The electronic device of claim 6, wherein a thickness of the second spacer and a thickness of the fourth spacer are different.

8. The electronic device of claim 6, wherein a thickness of the first spacer and a thickness of the third spacer are different.

9. The electronic device of claim 1, wherein the transparent conductive layer comprises a hollow portion, and the hollow portion overlaps the first spacer.

10. The electronic device of claim 1, further comprising:
a protection layer disposed on the transparent conductive layer.

11. An electronic device, comprising:
a substrate;
a thin-film transistor disposed on the substrate;
a first organic layer disposed on the thin-film transistor and having a via;
a transparent conductive layer disposed on the first organic layer and electrically connected to the thin-film transistor through the via;
a second organic layer at least partially disposed in the via; and
a first spacer disposed on the second organic layer and overlapping the second organic layer, wherein the transparent conductive layer is disposed between the first spacer and the second organic layer, in a cross-sectional view of the electronic device, a first width of the first spacer close to the second organic layer is less than a second width of the first spacer away from the second organic layer.

12. The electronic device of claim 11, wherein the second organic layer comprises a protruding portion, and a portion of the transparent conductive layer covering the protruding portion abuts against the first spacer.

13. The electronic device of claim 11, wherein a maximum distance between a top surface of the transparent conductive layer and a top surface of the first organic layer is equal to a thickness of the first spacer.

14. The electronic device of claim 11, wherein a top surface of the transparent conductive layer comprises a recessed portion, and a top surface of the first spacer is correspondingly embedded into the recessed portion.

15. The electronic device of claim 11, wherein the transparent conductive layer comprises a hollow portion, and the hollow portion overlaps the first spacer.

16. The electronic device of claim 11, further comprising:
a protection layer disposed on the transparent conductive layer.

17. The electronic device of claim 11, wherein the first spacer and the transparent conductive layer abut against each other.

18. The electronic device of claim 11, further comprising:
a second spacer disposed on the second organic layer and overlapping the second organic layer, wherein the transparent conductive layer is disposed between the second spacer and the second organic layer, and there is a gap between the second spacer and the transparent conductive layer.

19. The electronic device of claim 18, wherein a thickness of the first spacer and a thickness of the second spacer are different.

20. The electronic device of claim 18, wherein a thickness of the first spacer and a thickness of the second spacer are the same.
